(19) United States
(12) Patent Application Publication
(10) Pub. No.: US 2025/0291782 A1
(43) Pub. Date: Sep. 18, 2025

(54) VECTOR SEARCH IN EMBEDDED DATABASES

(71) Applicant: Couchbase, Inc.

(72) Inventors: Jens Peter Alfke, Alameda, CA (US); Wayne Anthony Carter, Miami Beach, FL (US)

(21) Appl. No.: 19/076,908

(22) Filed: Mar. 11, 2025

Related U.S. Application Data
(60) Provisional application No. 63/563,968, filed on Mar. 12, 2024.

(51) Int. Cl. G06F 16/22; G06F 16/28

(52) U.S. Cl. CPC G06F 16/2237; G06F 16/285

(57) ABSTRACT

A system stores a vector index based on vector data stored in a database and processes queries based on vector data using the vector index. The system stores a plurality of records in a database. The system receives a plurality of vectors, each vector associated with a record. The system stores, in a persistent storage, a vector index including tuples. Each tuple stores a vector, and an identifier of a record associated with the vector. The system receives a database query requesting a result set associated with a target record. The system identifies a target vector associated with the target record. The system accesses the vector index to retrieve a subset of vectors based on a distance from the target vector. The subset of vectors is loaded in memory from the persistent storage. The system determines a result set based on the subset of vectors.

### CROSS REFERENCE TO RELATED APPLICATIONS

This application claims the benefit of U.S. Provisional Application No. 63/563,968, filed Mar. 12, 2024, which is hereby incorporated in its entirety by reference.

### FIELD OF INVENTION

This disclosure relates in general to embedded databases and in particular to performing vector search in embedded databases.

### BACKGROUND

Vector embeddings are numerical representations of words, entities, documents, images or videos generated by neural networks and capture semantic information of the input. Distances between vector embeddings of two entities correlate to similarity between the corresponding entities. Vector search is performed to find similar items or data points represented as vectors, in large collections. vector search functionality is usually performed using processes that store the vector data in memory. This is practical on servers, but on client and embedded devices, leads to significant challenges in memory efficiency and scalability. Conventional techniques of vector searches in embedded databases suffer from high memory consumption and exhibit limited flexibility in updating indexes. Excessive memory usage may lead to poor performance or system crashes. This is particularly problematic in resource-constrained environments where maintaining an up-to-date and efficient search capability is significant. These limitations restrict the practical application of systems using vector search and hinder their adaptability and performance in dynamic data environments.

### SUMMARY

A system processes queries based on vectors stored in a database. A vector may also be referred to herein as a vector embedding. The system stores records in a database and receives vectors associated with records. Unlike conventional vector indexing methods, which store both centroids and vectors in memory, this system stores centroids in memory while placing vectors in persistent storage. A B-tree, or other ordered index, efficiently maps centroids to their associated vectors, enabling fast lookup while significantly reducing memory consumption and disk seeks. The vector index comprises tuples, each tuple storing a vector, and an identifier of a record associated with the vector. The system receives a database query specifying a target record associated with a target vector. The system accesses the vector index to retrieve a subset of vectors based on a distance from the target vector. The subset of vectors is loaded in memory from the persistent storage. The amount of memory used for processing the subset of records is significantly smaller than the total storage used by all the vectors. The system determines a result set based on the subset of vectors.

According to an embodiment, the vector index is stored in a database table. Each record of the database table stores a vector and an identifier of the record associated with the vector.

According to an embodiment, a record represents an external document and the vector is generated from at least a portion of the document.

According to an embodiment, the vector is generated from one of: a text portion of the document; an image attribute of the document; a video attribute of the document; or an audio attribute of the document. These are examples of data sources used for generating the vector embeddings. However, the techniques disclosed are not limited to these sources and can generate vector embeddings from other sources.

According to an embodiment, the database is an embedded database of an application executing on a memory-constrained device.

Embodiments of the invention include computer-implemented methods described herein, non-transitory computer readable storage media storing instructions for performing steps of the methods disclosed herein, and systems comprising one or more computer processors and computer readable non-transitory storage medium to perform steps of the computer-implemented methods disclosed herein.

### BRIEF DESCRIPTION OF THE DRAWINGS

FIG. 1 is an embodiment of a block diagram of a system environment in which an system operates for performing vector searches, according to an embodiment.

FIG. 2 illustrates an example architecture of a system for performing vector searches, according to an embodiment.

FIG. 3 shows a flowchart illustrating the process of creating a vector index according to an embodiment.

FIG. 4 shows a flowchart illustrating a processing of a query processing vector data, according to an embodiment.

FIG. 5 is a high-level block diagram illustrating a functional view of a typical computer system for use as one of the entities illustrated in the system environment of FIG. 1 according to an embodiment.

The figures depict embodiments of the present disclosure for purposes of illustration only. One skilled in the art will readily recognize from the following description that alternative embodiments of the structures and methods illustrated herein may be employed without departing from the principles, or benefits disclosed, of the disclosure described herein.

### DETAILED DESCRIPTION

A system according to various embodiments, performs vector searches in embedded database systems while reducing memory demands and enhancing index update flexibility without sacrificing search precision. An embedded database system represents a database system embedded in an application. Although the techniques disclosed are described in connection with embedded database systems, the techniques are applicable to database systems in general.

The system may run on a memory-constrained device such as a mobile device that is unable to load the entire vector space in memory. The system improves the computational resources consumed by the vector searches by loading only a limited amount of data to perform the vector searches. The system stores the vector data in persistent storage, for example, as a database table and runs queries that efficiently retrieve only a subset of data in memory and perform the vector search using the subset of vectors loaded in memory. The system utilizes an ordered indexing structure, such as a B-tree, LSM tree, or other ordered index, to efficiently map centroids to disk-stored vectors, minimizing query time. This system reduces memory usage from O(N) to O(k), where N is the number of vectors and k is the number of centroids, as only centroids remain in memory while vectors are stored in persistent storage. Attempting to load an entire data set of vectors in memory may either fail if the system runs out of memory. Alternatively, this may impact the performance of all processes running on the system since very little memory may remain available for executing the processes as the memory is consumed by the vector data. The system according to various embodiments is able to perform vector search on memory-constrained devices without running out of memory while handling large numbers of vectors.

According to an embodiment, the system implements an inverted file index that slices up the vector space into n partitions and maps each vector to a partition and tags each vector to the partition to which the vector is mapped. A partition is also referred to herein as a cluster. According to an embodiment, the system performs k-means clustering to determine the partitions and their centroids: it selects a set of samples of vectors and uses the sample set of vectors to select an initial set of centroids of an initial set of partitions. The system subsequently maps the remaining vectors to the initial set of partitions.

The system performs vector searches associated with a target vector by finding a set of partitions that either include the target vector or are near the target vector. The system may select partitions near the target vector by selecting partitions having centroids closest to the target vector. The system determines the distances between the target vector and the centroids of the partitions and selects the k nearest vectors within the vectors of the nearest partitions.

According to an embodiment, the system performs compression of the vectors to reduce the amount of data stored in each vector. The system may perform lossy comparison that allows approximate searches. The system may perform decompression of the vectors when performing distance calculations using the vectors. However, the compression makes the processing of the vectors efficient since a much smaller amount of data needs to be read and processed by the system.

### System Environment

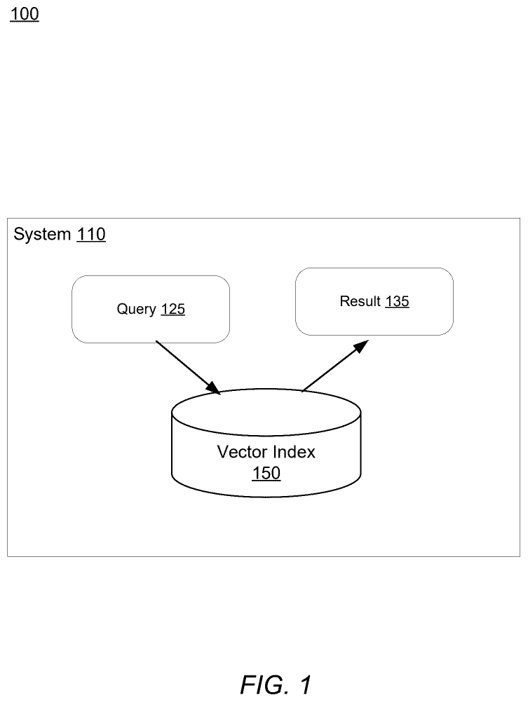

FIG. 1 is an embodiment of a block diagram of a system environment in which a system operates for performing vector searches, according to an embodiment. In the embodiment shown, the system environment includes an system 110. Other embodiments may use more or fewer or different systems than those illustrated in FIG. 1. Functions of various modules and systems described herein can be implemented by other modules or systems than those described herein.

According to an embodiment, the system 110 generates vector embeddings from various types of input including text, video, images, audio, and so on. Vector embeddings represent data points in high dimensional space, for example, 128 dimensions, 1024 dimensions, 2048 dimensions, and so on. Vector embeddings can be compared for identifying similar vector embeddings. The comparison may be based on vector distances such as Euclidean distances between data points or using a metric such as cosine similarity metric.

The system 110 stores data in a data store. The system 110 receives query 125 based on the data stored in the data store. The system 110 processes the query 125 using the data stored in the data store 230 to determine results 135 that satisfy the query 125. The system uses the vector index 150 to efficiently execute the query by performing vector searches across attributes or fields storing vectors. The system 110 returns the results 135 to requestor that sent the query 125.

### System Architecture

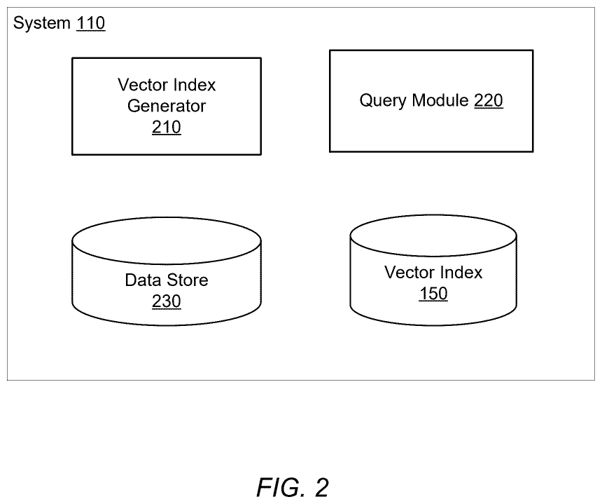

FIG. 2 illustrates an example architecture of a system for performing vector searches, according to an embodiment. The database system includes a vector index generator 210, a query module 220, a data store 230, and a vector index 150. Other embodiments may include more of fewer modules than those indicated herein.

The data store 230 and the vector index 150 may be objects stored in the same database. According to an embodiment, the vector index stores vectors and associates them with records stored in the data store 230. A vector may be represented as a sequence of numeric values. The data store 230 may be a relational database that stores records in database tables or relations. The data store 230 may store data as documents that include attributes or fields such that the system 110 is a document database system. The data store 230 may store information describing entities or items, for example, products of an enterprise store, user information, and so on. The entities represented in the system 110 include fields or attributes. The attributes may be stored as columns of a table in a relational database system or as fields of documents in a document database system. The data stored in the data store 230 may include scalar attributes, for example, attributes of type integer, date, string, floating point numbers, and so on. For example, if the entity represented in the database system is a product of an enterprise, the scalar attributes may represent price of the product, a name of the product and so on. The data may also include “blob” attributes containing binary data such as images, video or other media. Blob attributes may also store precomputed vectors.

The vector index generator 210 generates the vector index 150. The query modules 220 receives queries for processing and generates execution plans for executing the queries. The query may be based on an attribute represented as a vector that has a corresponding vector index. The execution plan uses the vector index for efficiently processing the query.

According to an embodiment, the vector index generator 210 performs clustering of vectors to group the vectors into “buckets” for efficiently processing queries based on vectors such as nearest neighbor queries. According to an embodiment, the system performs clustering of vectors using inverted files. The clustering may be performed using a library such as open-source FAISS (Facebook AI Similarity Search) but is not limited to any specific implementation.

The system processes queries whether or not the vectors have been clustered. For example, if a small set of vectors is available, the system may not perform clustering and treat the entire set of vectors as a single cluster. The system defers clustering until enough data is available. The clustering step is also referred to herein as training. According to an embodiment, training is performed by selecting a sample of vectors and performing clustering to determine an initial set of centroids that are used to assign the remaining vectors to buckets, each bucket corresponding to a centroid storing vectors that are within a threshold distance of the centroid.

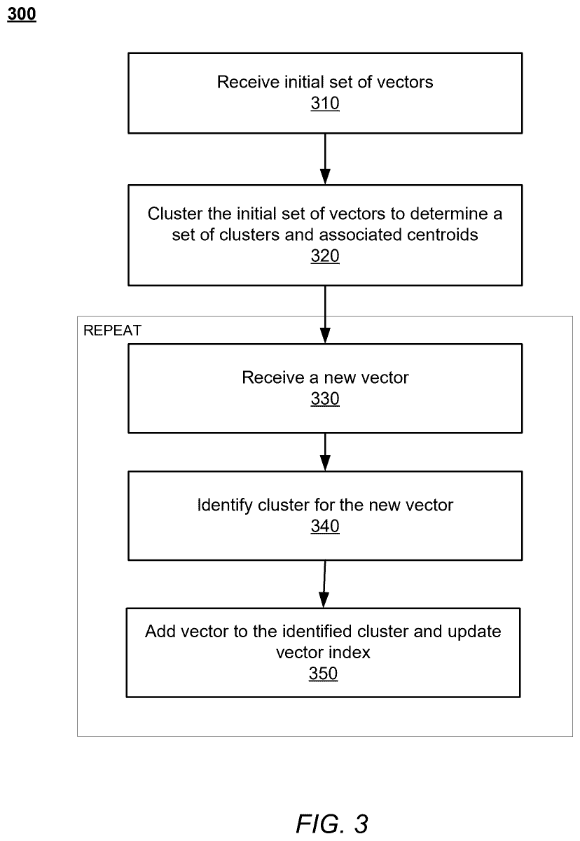

FIG. 3 shows a flowchart illustrating the process of creating a vector index according to an embodiment. The steps may be executed in an order different from that indicated herein. The steps may be performed by a system, for example, modules of the system 110 such as vector index generator 210 and query module 220.

According to an embodiment, the system uses an inverted file (IVF) for vector indexing. The steps of the process executed by the system are as follows. The system receives 310 a set of vectors that may be stored in a database. The vectors may correspond to one or more attributes of records stored in the data store 230. For example, the data store 230 may store the vectors directly within its records; or it may include an image attributes, and the vectors represent vector embeddings of the images. As another example, the data store 230 may store records that include a text attribute and the vectors represent vector embeddings of values stored in the text attribute.

The system performs a training phase in which centroids of various clusters of vectors are determined. According to an embodiment, the system maintains a reserved bucket or cluster of unindexed vectors. The system receives 310 an initial set of vectors and stores them in the reserved bucket. If any queries are received, the results are searched within the reserved bucket and query execution may not be efficient. The system performs the training phase by clustering 320 the initial set of vectors into a set of clusters, each cluster having a centroid. A centroid may also be referred to as a centroid vector herein. The system may perform clustering using k-means clustering of the vectors or any other clustering technique. Accordingly, the system determines the centroids based on the initial set of vectors. The information describing the centroids and mappings of the vectors in the initial set of vectors is stored in the vector index.

The system adds vectors received subsequently to one of the clusters determined in the training phase. Accordingly, the system may repeat the steps 330, 340, 350 multiple times as additional vectors are received. The system receives 330 a new vector. The system identifies 340 a cluster for the new vector. For example, the system may identify the cluster for the new vector as the cluster that has a centroid that is closest to the new vector. The system adds 350 the new vector to the cluster that was identified 340. The system updates the vector index with the information mapping the new vector to the identified cluster.

According to an embodiment, if a large number of vectors are available initially, the system performs sampling to determine a subset of vectors and perform clustering of the vectors to determine a set of clusters. The system uses the centroids of the clusters for determining which clusters the remaining vectors or any vectors received subsequently belong. For example, each vector is assigned to the cluster corresponding to the centroid that is nearest to the vector.

The training process may use a fraction of the eventual data set of vectors (for example, 1%-10%) for optimal results. Each vector in the data set is associated with the centroid number of its enclosing partition, for example, by finding the centroid point closest to that vector. Each vector is also associated with a unique document identifier integer, docID selected by the application. The docID is used to link (join) the vector to the database record or document associated with the vector. The vector index requires docID to be unique. A docID refers to a record identifier. The record identified by the docID may be a document or a set of attributes or fields. The system creates N sets of vectors, each containing the vectors associated with one centroid. These sets are implemented to be efficiently iterable. These sets are referred to herein as buckets.

The system stores the cluster information in a vector index. According to an embodiment, the system uses centroids determined by the clustering to define a set of buckets that all the vectors are assigned to. The system stores information describing the clusters in a vector index. According to an embodiment, the vector index stores information describing the set of buckets in an ordered key-value store. The key-value store may represent a database table managed by an embedded database management system (DBMS). Accordingly, the vector index is stored in a persistent storage, for example, disk of a memory-constrained device such as a mobile device.

The system receives queries based on vectors, for example, k-nearest neighbor queries efficiently. The system processes the queries using very little memory by querying the DBMS. Accordingly, the system processes vector-based queries without loading the entire set of vectors in memory. This allows the queries to be efficiently processed by small devices with limited memory, for example, a memory-constrained device such as a mobile device.

During a query, the k nearest neighbors of a target vector are located by performing the following steps. The system identifies the p nearest centroids to the target vector, where p is called the probe count. The system iterates over all vectors in all buckets associated with those nearest centroids, computing the distance to each vector from the target vector, and keeping the vectors with the k smallest distances.

Vectors stored in the buckets may be encoded using techniques such as product quotient and scalar quotient. Encoding is lossy compression that greatly reduces the size of the vector's representation; the decoded vector is allowed to differ somewhat from the true vector. The system is able to perform lossy compression because vector search is an approximate nearest-neighbor search.

### Vector Indexing on Memory-Constrained Devices

In existing implementations (such as ones included in FAISS) buckets are implemented using in-memory data structures that require all the vectors to exist in the computer's address space. Such implementations may include a memory-mapped implementation that reduces the amount of physical RAM used, but it's an ad-hoc file format, not a true database.

The system may encode vectors to compress them for efficient storage. The system decompresses the vectors for processing for example, for calculation of vector distances for nearest neighbor queries. According to an embodiment, the system stores the data associated with vectors in a database management system (DBMS). The data stored in the DMBS includes the set of centroid vectors and any database objects such as database tables used for encoding/decoding of vectors, as well as information describing all the buckets containing the vectors in the data set. An example of DBMS used for storing the vector index is SQLite™, an open-source, embedded database engine that uses SQL to store and query data. However, the system may use any database providing an ordered key-value store, such as a b-tree. The system may store the vector index information in DBMS that are not relational nor use SQL. The system stores the data associated with vectors in a DBMS that stores data primarily in persistent storage such as a disk or flash drive. The system only reads minimum amount of data into memory to process a query based on the vector data. According to an embodiment, the system stores vector index in a DBMS that allocates a fixed-size block cache and needs little additional storage. The system may store the vector index in an embedded database that has a block cache size of 20 MB.

According to an embodiment, the system stores the data required to manage IVF index, including the set of centroid points and encoding/decoding information in one record in the database. Typically, the vector library (e.g. FAISS) implementing the centroids and encoder provides a means to read and write this data to a memory blob, which is easy to store in a record.

According to an embodiment, the system implements the set of buckets as a single table in the database. A table here describes that entity in any DBMS that (1) allows any number of records to be stored, updated and deleted efficiently; (2) identifies each record by a unique primary key, and allows a variable-length value to be stored alongside; (3) can very efficiently iterate over records in primary-key order, given a range of keys.

The primary key for the vector index table is represented as the tuple (centroidID, docID) where centroidID represents an identifier of the centroid of the cluster associated with a vector and docID represents the identifier of the record or the document associated with the vector. The vector representing the centroid may be stored as a BLOB (binary large object) in a separate table storing vectors and is identified by the centroid identifier centroidID that may be a primary key of the table storing the vectors. The system performs ordering for such a tuple by comparing the first component (centroid) first, and then if the values of the first component are equal, then comparing the second component (docID). According to an embodiment, the system gains extra efficiency by coalescing the tuple into a single integer s×centroid+docID. Here s is a constant, usually a large power of two that is larger than the maximum value of docID. This transformation is reversible, and the ordering of the resulting single integers is the same as the tuples. This transformation improves the computational efficiency of the process since one integer is smaller than two, and some DBMS implementations (including SQLite) are significantly more efficient when the primary key is a single integer, because they can avoid creating a secondary index to sort the keys.

According to an embodiment, the system uses a secondary table, the docID index that has as primary key the docID along with the vector data. This table allows a vector in the vector index table to be located quickly given only its docID. This table is updated as necessary to remain consistent with the vector index table. In many DBMSs (including SQLite) this type of table can be managed automatically as an index, but in others DBMSs, the secondary table may have to be updated manually.

According to various embodiments, the vector index table implements the entire set of buckets of the IVF process. The system inserts a vector by inserting a record into the DBMS whose primary key is constructed as described herein, and whose value is the vector itself. The vector may be stored in its raw form, for example, as a consecutive array of 32-bit IEEE floating point numbers. Alternatively, the vector may be stored as data encoded by an indexing library.

The system removes a vector, given its docID, by first looking up the docID in the vector index, then using the primary key discovered to look up and delete the record from the vector index table. The system may have to remove the entry from the docID index. The system updates a vector, given its docID, by applying first a deletion and then an insertion, thereby performing an upsert operation. A DBMS may optimize the upsert step to a single operation. The system may read a vector from the DBMS given its docID by first looking the docID up in the docID index, then using the primary key thus discovered to look up the vector in the vector index table and returning the value. The value, if encoded, is decoded for processing, and may be approximate.

### Processing Vector Search Queries

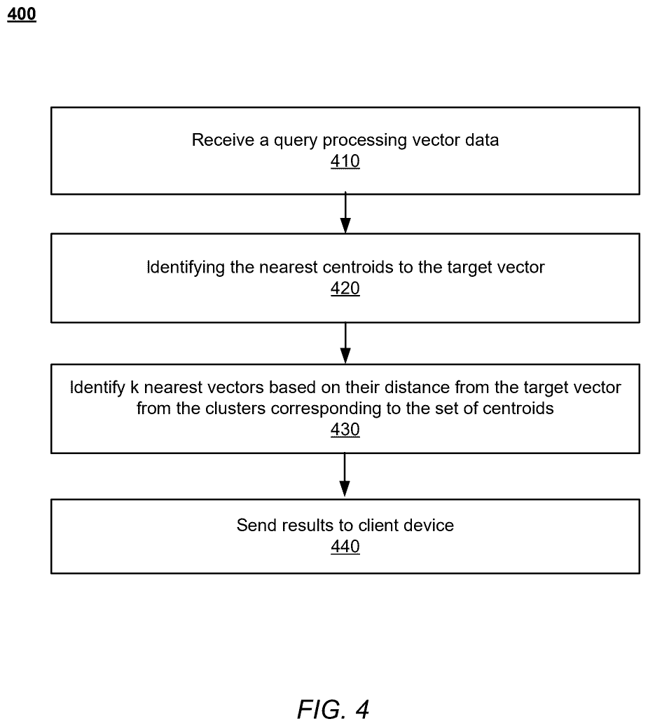

FIG. 4 shows a flowchart illustrating a processing of a query processing vector data, according to an embodiment. The steps may be executed in an order different from that indicated herein. The steps may be performed by a system, for example, by modules of the system 110 such as the query module 220.

The system receives 410 a query processing vector data, for example, a k-nearest-neighbors query that requests k-nearest-neighbors from a target vector based on vector distances between the target vector and vectors stored in the database. For example, if the vectors represent an image, the query may request k images stored as vectors that are closest to the target image in similarity. The similarity metric may be cosine similarity metric. Similarly, if the vectors represent documents or text fields of records, the query may represent k documents stored in the database that are closest in similarity to a target document.

The query module 220 identifies 420 the nearest p centroids to the target vector using the vector table that represents an inverted file. According to an embodiment, the value p is determined as a predetermined fraction of the total number of clusters. The system identifies the k nearest vectors based on their distance from the target vector from the clusters corresponding to the p centroids

According to an embodiment, the query is a nearest neighbor query and the system identifies 440 the k nearest vectors based on their distance from a target vector specified by the query. According to an embodiment, the system creates an empty result list of (distance, docID) tuples. The system keeps the list ordered by distance. The system maintains a maximum capacity of the list to be k, the number of results requested by the query. The system may use data structures such as a heap or tree to optimize the list. The system may implement the list as part of a higher-level query operation supported by the DBMS.

For each of the centroids found in step 420, the system may build structures for use by the encoder/decoder, for example, by building look-up tables optimizing decoding of vectors associated with each centroid. The system iterates the vector table for all records associated with the centroid. For example, the system may iterate over records in the vector index table starting from primary key (centroidID, 0) and ending before primary key (centroidID, 00), i.e. ending at the largest possible docID. For each iterated record, the system decodes the vector value if it is stored in encoded form and computes the distance to the target vector. The distance to the target vector may be computed using distance metrics such as Euclidean distance or cosine distance. The system inserts the resulting (distance, docID) tuple into the result list, maintaining its sort order. If the list grows beyond size k, the system removes the last element to keep the size of the list to within k while keeping the list sorted. As the system completes iterating through all the vectors of all the clusters identified in the steps 420, the result list stores the k nearest vectors to the target vector. The list of the k nearest vectors may be an approximate list. The system sends 440 the result list containing the docIDs of the k nearest vectors, and their distances from the target vector to the application.

The steps for determining the k nearest vectors to the target vector may be implemented using a high-level query language like SQL. The implementation load only a subset of the stored vectors at a time in the memory and stores the entire set of vectors on a persistent storage.

According to an embodiment, the system performs a training process to generate the set of centroids. The system allows the training process to be transparent to the application, i.e., the training process is performed automatically without receiving explicit instructions from the application. The system typically fetches the data set, including vectors, over time. For example, an application may download a large database from the server, or it may be generating vectors from data using a slow machine learning model. The application may be executed asynchronously without blocking until the retrieval operation is completed. The system allows users to search during this interval. However, during this step, training the vector index is likely to produce poor results due to insufficient data, and searching relies on the index. As a result, the system uses an out-of-range centroid number (for example, negative 1 (i.e., −1) which is reserved for unindexed vectors. This is referred to as the unindexed centroid. Initially, there is no vector index created by the vector library, nor any centroids. When a vector is to be inserted, but there is no vector index yet, the system uses the unindexed centroid instead of computing a true one. Accordingly, all vectors are stored in a cluster corresponding to the unindexed centroid.

Periodically, if no vector index exists, the system examines the database to determine if there are at least a threshold number of vectors available to perform indexing. The system may perform this before a query, or after insertions, or at a time when the application is idle. The system counts the total number of vectors. If the total number of vectors is below the threshold value, the system does not build the vector index. The system determines the threshold value based on the number of desired centroids and/or the known eventual size of the data set. If the system determines that there are enough vectors, the system trains a vector index. The system trains the vector index by determining the set of centroids, as well as other parameters used for encoding. The system saves the index data to its record in the DBMS. The system scans the range of records with primary keys (unindexed-centroidID, 0) to (unindexed-centroidID, ∞). Each vector found is inserted (again) into the database following the above procedure. This computes the nearest centroid and inserts it under a new primary key with that centroid. Finally, the entire range of records that were iterated above are deleted from the table.

If the database receives a query for processing, if no vector index exists yet the system produces a set containing only the unindexed centroid. Otherwise, the system adds the unindexed centroid to the set of p nearest centroids. The system produces correct results for all operations even when no vector index exists. The performance of query execution may be slow without the vector index since all queries in the unindexed cluster need to be scanned. However, this situation only occurs when the data set is fairly small and as a result the performance is not significantly impacted.

According to an embodiment, the system adds vectors to the unindexed centroid, even after a vector index was created. This allows system to insert new vectors efficiently since the system avoids the overhead of determining a centroid and encoding the vector. To avid degrading query performance as more unindexed vectors are added, the system periodically indexes the vectors in the unindexed cluster. This optimization particularly improves performance on lower-end embedded devices with less computing power, especially if data must be collected in real-time.

Integration with a Database

The techniques disclosed herein may be used as an addition to a DBMS or to a database-based application. The DBMS used for vectors as described herein may be the same database instance used for storing other data. For example, the vectors may be stored in a different database object such as a different table/collection/b-tree/etc. compared to the database object storing the remaining records. The system uses the docID as a foreign key relating a vector back to the record it originates from or relates to.

In some embodiments, the docID does not refer directly to a document but uses some level of indirection. For instance, in a schema where a document contains multiple vectors, the system uses an intermediate table mapping the docID to a document key plus an identifier of which vector it is. Accordingly, the system may use a join table to indirectly associate vectors with the corresponding record.

As records that own vectors are created/updated/deleted, the DBMS may automatically update the vector index. In embodiments where the database is an RDBMS (relational database management system) the system uses triggers. The system may update, the vector index less often to reduce overhead. Accordingly, the system determines the frequency of updating the vector index based on the load on the server or the overhead caused by the vector index update.

According to an embodiment, the system stores in each record, a sequence number. Accordingly, every time a record is created or updated, its sequence number is assigned the next value from a global counter. The system may keep a deleted record as a “tombstone”, marked as deleted, and also assigned a new sequence. Alternatively, the system may update the vector index immediately by deleting a vector when a record in the main table is deleted. In these embodiments, the vector index stores the value of the sequence-number counter that was current at the time it was last updated. At any future time when the index is to be updated, the system searches the document table for records whose sequence number is greater than the vector index's stored sequence. Those records are the ones whose vectors need to be (re) indexed. After this, the system updates the vector index's sequence again.

There system utilizes synergies to storing indexed vectors in the same database as the rest of the application's data. The vector index can be queried as part of a larger database query involving the main tables/documents. The vector index is transactionally in sync with the rest of the database. For instance, aborting a transaction that modified a document's vector also backs out the change to the vector index, leaving everything self-consistent. Similarly, crashes that (implicitly) cause an in-progress transaction are aborted.

The RAM (random access memory or memory) usage by a DBMS is primarily of a fixed-size block cache. Since the application has already allocated this cache as part of opening its database, the effective RAM overhead of querying the vector index is minimized.

### Technological Improvements

Using an embedded DBMS instead of in-memory data structures greatly reduces memory usage. The DBMS uses block caching to keep a small memory footprint regardless of the size of the database. This makes vector indexing and search feasible on RAM-constrained devices such as mobile phones.

The ACID properties of a DBMS (Atomic, Consistent, Isolated, Durable) ensure the persistent data is durable and remains self-consistent even in the event of application crashes, operating system panics, or power failures. These qualities are difficult to achieve using regular file I/O operations, as in the index serialization of existing libraries like FAISS. Again, this is a proportionally greater benefit for memory-constrained devices such as mobile devices as opposed to servers, since (a) mobile devices operate in unreliable environments, and (b) an embedded vector database by definition runs inside a third-party application and is therefore affected by factors outside its control that can cause crashes.

The vector data may be queried by the application independent of its size, even if no clustering (training) can be performed yet due to insufficient data. Then the indexing may be done later when enough data is available for good training. This benefits mobile devices, since the entire vector data set is unlikely to be provided up-front and must be downloaded or computed asynchronously as data arrives. Furthermore, applications commonly use sync or replication to remain up to date with remote databases, causing frequent changes in data. Mobile applications may initially work with a small subset of the entire data set, then progressively download more of it over time as needed to satisfy the user's requests. Search functionality remains available to the user, without the user having to wait for more vectors to be downloaded or computed. This provides better user experience compared to systems that prevent users from performing common activity like searching in similar situation.

The updates to the set of vectors are more efficient than with conventional serialization mechanisms, because: the DBMS performs such operations efficiently. Several conventional systems require writing the entire data set to disk after changing even one vector. Mechanisms that do allow incremental updates are typically less optimized compared to a DBMS.

### Performance Results

A benchmarking tool was executed under multiple configurations, with and without the techniques disclosed herein. The hardware used was a mobile phone, specifically an iPhone™ 14 with iOS 17.4. The data set processed was SIFTIM, a standard data set used for vector search testing and benchmarking that includes 1 million 128-dimensional vectors. Each query located the 10 nearest vectors to a target vector. Performance was computed from running 1000 queries.

The following Table I shows the results of the performance benchmark studies. The first row is the baseline that shows performance of storing the 1M vectors on disk (in an SQLite database table, in this case) and performing a linear scan of all the vectors, computing the distance to each and keeping the 10 lowest.

The last two rows show a use case using the techniques disclosed herein according to various embodiments. The system divided the data set into 4000 centroids (and probed the 10 nearest centroids.) Accordingly, for any one query, only 0.25% of the vectors need to be read from disk and have distances computed.

TABLE I

| | | Vector | Database | RAM | |
|---|---|---|---|---|---|
| Indexing | | Encoding | Size | Usage | Queries/second |
| — | | — | 500 MB | 10 MB | 5 |
| 2 | centroids | none | 500 MB | 10 MB | 4 |
| 2 | centroids | SQ8 | 125 MB | 10 MB | 4 |
| 4000 | centroids | none | 500 MB | 10 MB | 1068 |
| 4000 | centroids | SQ8 | 125 MB | 10 MB | 1200 |

As shown in table I, the various queries were executed with fixed RAM usage independent of the number of vectors being processed. Conventional techniques use RAM that increases with increase in the number of vectors being processed. As a result, the conventional techniques are unable to handle the data if the number of vectors processed increases above certain threshold. In contrast the system according to various embodiments uses small amount of RAM that is independent of the size of the database being processes and. The system disclosed according to various embodiments does not impact the performance of other applications running on the device since the RAM usage as a result of database query processing is controlled and minimum. Accordingly, the techniques disclosed improve utilization of computational resources such as memory compared to conventional for processing queries such as nearest neighbor queries.

### Computer Architecture

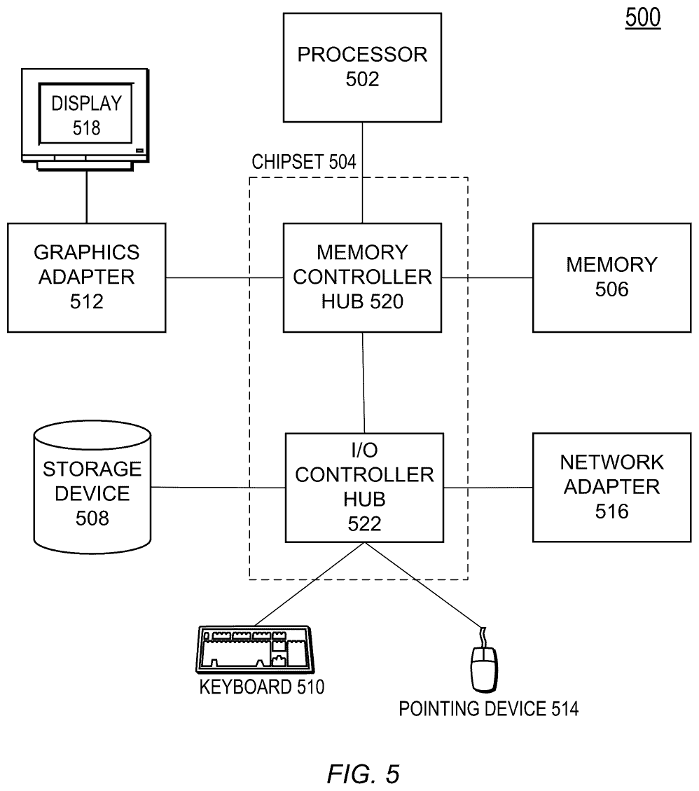

FIG. 5 is a high-level block diagram illustrating a functional view of a typical computer system for use as one of the entities illustrated in the system environment of FIG. 1 according to an embodiment. Illustrated are at least one processor 502 coupled to a chipset 504. Also coupled to the chipset 504 are a memory 506, a storage device 508, a keyboard 510, a graphics adapter 512, a pointing device 514, and a network adapter 516. A display 518 is coupled to the graphics adapter 512. In one embodiment, the functionality of the chipset 504 is provided by a memory controller hub 520 and an I/O controller hub 522. In another embodiment, the memory 506 is coupled directly to the processor 502 instead of the chipset 504.

The storage device 508 is a non-transitory computer-readable storage medium, such as a hard drive, compact disk read-only memory (CD-ROM), DVD, or a solid-state memory device. The memory 506 holds instructions and data used by the processor 502. The pointing device 514 may be a mouse, track ball, or other type of pointing device, and is used in combination with the keyboard 510 to input data into the computer system 500. The graphics adapter 512 displays images and other information on the display 518. The network adapter 516 couples the computer system 500 to a network.

As is known in the art, a computer system 500 can have different and/or other components than those shown in FIG. 5. In addition, the computer system 500 can lack certain illustrated components. For example, a computer system 500 acting as a server (e.g., a query server 112) may lack a keyboard 510 and a pointing device 514. Moreover, the storage device 508 can be local and/or remote from the computer system 500 (such as embodied within a storage area network (SAN)).

The computer system 500 is adapted to execute computer modules for providing the functionality described herein. As used herein, the term “module” refers to computer program instruction and other logic for providing a specified functionality. A module can be implemented in hardware, firmware, and/or software. A module can include one or more processes, and/or be provided by only part of a process. A module is typically stored on the storage device 1008, loaded into the memory 506, and executed by the processor 502.

The types of computer systems 500 used by the entities of FIG. 1 can vary depending upon the embodiment and the processing power used by the entity. For example, a client device 120 may be a mobile phone with limited processing power, a small display 518, and may lack a pointing device 514. The entities of the system 110, in contrast, may comprise multiple blade servers working together to provide the functionality described herein.

### ADDITIONAL CONSIDERATIONS

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

The language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

Some portions of the above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the element or component is present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs that may be used to employ the described techniques and approaches. Thus, while particular embodiments and applications have been illustrated and described, it is to be understood that the described subject matter is not limited to the precise construction and components disclosed.

What is claimed is:

1. A computer-implemented method for processing queries based on vectors stored in a database, the computer-implemented method comprising:
storing in the database, a plurality of records;
receiving a plurality of vectors, wherein a vector comprises a sequence of numeric values, each vector associated with a record of the plurality of records;
storing, in a persistent storage, a vector index comprising tuples, wherein each tuple stores a vector and an identifier of a record associated with the vector;
receiving a database query requesting a result set associated with a target record;
identifying a target vector associated with the target record;
accessing the vector index to retrieve a subset of vectors based on a distance from the target vector, wherein the subset of vectors is loaded in memory from the persistent storage;
determining a result set based on the subset of vectors; and
sending the result set.

2. The computer-implemented method of claim 1, wherein the vector index is generated by performing steps comprising:
receiving an initial set of vectors;
clustering the initial set of vectors to generate a plurality of clusters of vectors, each cluster associated with a centroid vector, wherein the vector index stores an identifier of a centroid associated with a vector; and
repeatedly performing:
receiving a new vector;
responsive to receiving the new vector, identifying a cluster associated with the new vector based on a vector distance between the new vector and centroid vectors associated with one or more clusters; and
updating the vector index with a mapping of the new vector and the cluster identified.

3. The computer-implemented method of claim 2, wherein retrieving a subset of vectors comprises:
identifying a set of centroids associated with the target vector; and
selecting a subset of tuples from the vector index based on the distance of the vector of each tuple, wherein each tuple selected has a centroid matching a centroid from the set of centroids.

4. The computer-implemented method of claim 1, wherein vector index is stored in a database table, wherein each record of the database table stores a vector and an identifier of the record associated with the vector.

5. The computer-implemented method of claim 1, wherein a record represents a document, wherein the vector is generated from at least a portion of the document.

6. The computer-implemented method of claim 5, wherein the vector is generated from one of:
a text portion of the document;
an image attribute of the document;
a video attribute of the document; or
an audio attribute of the document.

7. The computer-implemented method of claim 1, wherein the database is an embedded database of an application executing on a memory-constrained device.

8. A non-transitory computer readable storage medium, storing instructions that when executed by one or more computer processors cause the one or more computer processors to perform steps of a method for processing queries based on vectors stored in a database, the steps comprising:
storing in the database, a plurality of records;
receiving a plurality of vectors, wherein a vector comprises a sequence of numeric values, each vector associated with a record of the plurality of records;
storing, in a persistent storage, a vector index comprising tuples, wherein each tuple stores a vector and an identifier of a record associated with the vector;
receiving a database query requesting a result set associated with a target record;
identifying a target vector associated with the target record;
accessing the vector index to retrieve a subset of vectors based on a distance from the target vector, wherein the subset of vectors is loaded in memory from the persistent storage;
determining a result set based on the subset of vectors; and
sending the result set.

9. The non-transitory computer readable storage medium of claim 8, wherein the instructions further cause the one or more computer processors to perform steps for generating the vector index, comprising:
receiving an initial set of vectors;
clustering the initial set of vectors to generate a plurality of clusters of vectors, each cluster associated with a centroid vector, wherein the vector index stores an identifier of a centroid associated with a vector; and
repeatedly performing:
receiving a new vector;
responsive to receiving the new vector, identifying a cluster associated with the new vector based on a vector distance between the new vector and centroid vectors associated with one or more clusters; and
updating the vector index with a mapping of the new vector and the cluster identified.

10. The non-transitory computer readable storage medium of claim 9, wherein retrieving a subset of vectors comprises:
identifying a set of centroids associated with the target vector; and
selecting a subset of tuples from the vector index based on the distance of the vector of each tuple, wherein each tuple selected has a centroid matching a centroid from the set of centroids.

11. The non-transitory computer readable storage medium of claim 8, wherein vector index is stored in a database table, wherein each record of the database table stores a vector and an identifier of the record associated with the vector.

12. The non-transitory computer readable storage medium of claim 8, wherein a record represents a document, wherein the vector is generated from at least a portion of the document.

13. The non-transitory computer readable storage medium of claim 12, wherein the vector is generated from one of:
a text portion of the document;
an image attribute of the document;
a video attribute of the document; or
an audio attribute of the document.

14. The non-transitory computer readable storage medium of claim 8, wherein the database is an embedded database of an application executing on a memory-constrained device.

15. A computer system comprising:
one or more computer processors; and
a non-transitory computer readable storage medium, storing instructions that when executed by one or more computer processors cause the one or more computer processors to perform steps of a method for processing queries based on vectors stored in a database, the steps comprising:
storing in the database, a plurality of records;
receiving a plurality of vectors, wherein a vector comprises a sequence of numeric values, each vector associated with a record of the plurality of records;
storing, in a persistent storage, a vector index comprising tuples, wherein each tuple stores a vector and an identifier of a record associated with the vector;
receiving a database query requesting a result set associated with a target record;
identifying a target vector associated with the target record;
accessing the vector index to retrieve a subset of vectors based on a distance from the target vector, wherein the subset of vectors is loaded in memory from the persistent storage;
determining a result set based on the subset of vectors; and
sending the result set.

16. The computer system of claim 15,
wherein the instructions further cause the one or more computer processors to perform steps for generating the vector index, comprising:
receiving an initial set of vectors;
clustering the initial set of vectors to generate a plurality of clusters of vectors, each cluster associated with a centroid vector, wherein the vector index stores an identifier of a centroid associated with a vector; and
repeatedly performing:
receiving a new vector;
responsive to receiving the new vector, identifying a cluster associated with the new vector based on a vector distance between the new vector and centroid vectors associated with one or more clusters; and
updating the vector index with a mapping of the new vector and the cluster identified.

17. The computer system of claim 16, wherein retrieving a subset of vectors comprises:
identifying a set of centroids associated with the target vector; and
selecting a subset of tuples from the vector index based on the distance of the vector of each tuple, wherein each tuple selected has a centroid matching a centroid from the set of centroids.

18. The computer system of claim 15, wherein vector index is stored in a database table, wherein each record of the database table stores a vector and an identifier of the record associated with the vector.

19. The computer system of claim 15, wherein a record represents a document, wherein the vector is generated from at least a portion of the document.

20. The computer system of claim 19, wherein the vector is generated from one of:
a text portion of the document;
an image attribute of the document;
a video attribute of the document; or
an audio attribute of the document.
